(19) United States
(12) Patent Application Publication
(10) Pub. No.: US 2025/0207282 A1
(43) Pub. Date: Jun. 26, 2025

(54) DEVICE AND METHOD FOR METAL PREPARATION BY ELECTRO-REDUCTION OF MOLTEN SALT

(71) Applicant: NORTH CHINA UNIVERSITY OF SCIENCE AND TECHNOLOGY, Tangshan (CN)

(72) Inventors: Jinglong LIANG, Tangshan (CN); Hui LI, Tangshan (CN); Fucheng ZHANG, Tangshan (CN); Dongxing HUO, Tangshan (CN); Zhinan YANG, Tangshan (CN); Xiwei QI, Tangshan (CN); Yu YANG, Tangshan (CN); Le WANG, Tangshan (CN); Bangmeng QU, Tangshan (CN); Chang LIU, Tangshan (CN)

(73) Assignee: NORTH CHINA UNIVERSITY OF SCIENCE AND TECHNOLOGY, Tangshan (CN)

(21) Appl. No.: 18/938,264

(22) Filed: Nov. 5, 2024

(30) Foreign Application Priority Data
Dec. 21, 2023 (CN) 202311772758.2

(51) Int. Cl. C25C 7/00; C25C 3/08; C25C 3/34; C25C 7/06

(52) U.S. Cl. CPC C25C 7/005; C25C 3/08; C25C 3/28; C25C 7/06

(57) ABSTRACT

A device and a method for metal preparation by electro-reduction of a molten salt are provided. The device includes a reactor, an electrical conductor, a power supply, a gas charging and discharging mechanism, and a closure mechanism; the reactor is a barrel body with a conductive base plate and an insulated peripheral wall and opens at one end, a barrel cavity of the reactor is configured to lay down a reactant and a molten salt substance; the electrical conductor is configured to be inserted into the molten salt substance; the reactor and the electrical conductor are disposed inside the closure mechanism; a positive pole of the power supply is electrically connected to the electrical conductor, and a negative pole is electrically connected to the conductive base plate; the gas charging and discharging mechanism is configured to continuously charge a protective gas into the reactor while removing an exhaust gas.

### CROSS-REFERENCE TO RELATED APPLICATIONS

This application claims priority of Chinese Patent Application No. 202311772758.2, filed on Dec. 21, 2023, the entire contents of which are incorporated herein by reference.

### TECHNICAL FIELD

The present disclosure relates to the field of molten salt electro-reduction technology, and in particular relates to a method and a device for metal preparation by electro-reduction of molten salt.

### BACKGROUND

Metal smelting process plays a significant role in various fields of national production and life. As a big iron and steel producing country, China's annual output of pig iron exceeds 500 million tons. Currently, China's ironmaking process is dominated by blast furnace ironmaking. First of all, the blast furnace ironmaking process is complicated, including sintering, coking, blast furnace ironmaking and other processes, which needs to consume a large amount of energy and resources, with high costs, and is not conducive to environmental protection. Secondly, the blast furnace ironmaking process needs to consume a large amount of coke as a reducing agent and raw material, and the coking process not only needs to consume a large amount of non-renewable coal resources, but also produces a large amount of CO₂ and toxic gas. Lastly, blast furnace ironmaking produces a large amount of slag, which not only occupies a large amount of space resources, but also causes serious pollution to the soil.

Therefore, it is desired to provide a device and a method for metal preparation by electro-reduction of molten salt, which is capable of reducing the energy consumption and cost of a process for metal preparation and serving to protect the environment.

### SUMMARY

One or more embodiments of the present disclosure provide a device for metal preparation by electro-reduction of molten salt, the device for metal preparation by electro-reduction of molten salt including: a reactor, an electrical conductor, a power supply, a gas charging and discharging mechanism, and a closure mechanism; the reactor is a barrel body with a conductive base plate and an insulated peripheral wall and opens at one end, and a barrel cavity of the reactor is configured to lay down a reactant and a molten salt substance in sequence from bottom to top; the electrical conductor is configured to be inserted into the molten salt substance after melting; the reactor and the electrical conductor are disposed inside the closure mechanism, and the power supply is disposed outside the closure mechanism; the positive pole of the power supply is electrically connected with the electrical conductor, and the negative pole of the power supply is electrically connected to the conductive base plate; the gas charging and discharging mechanism is configured to continuously charge a protective gas into the reactor while removing an exhaust gas.

One or more embodiments of the present disclosure provide a method for metal preparation by electro-reduction of molten salt implemented by a device for metal preparation by electro-reduction of molten salt, the device includes a reactor, an electrical conductor, a power supply, a gas charging and discharging mechanism and a closure mechanism; the reactor is a barrel body with a conductive base plate and an insulated peripheral wall and opens at one end, a barrel cavity of the reactor is configured to lay down a reactant and a molten salt substance in sequence from bottom to top; the electrical conductor is configured to be inserted into the molten salt substance after melting; the reactor and the electrical conductor are disposed inside the closure mechanism, and the power supply is disposed outside the closure mechanism; a positive pole of the power supply is electrically connected to the electrical conductor, and a negative pole of the power supply is electrically connected to the conductive base plate; the gas charging and discharging mechanism is configured to continuously charge a protective gas into the reactor while removing an exhaust gas; and the method includes: laying the reactant and the molten salt substance in sequence from bottom to top in the barrel cavity of the reactor; heating the reactor until the molten salt substance melt and then inserting the electrical conductor into the molten salt substance; continuously charging the protective gas into the reactor through the gas charging and discharging mechanism while removing the exhaust gas, and switching on the power supply to perform a molten salt electro-reduction reaction; when the molten salt electro-reduction reaction in the barrel cavity is finished, disconnecting the power supply, pouring out the molten salt substance in an upper portion of the barrel cavity, and removing a retained substance in a lower portion of the barrel cavity; and obtaining a metal by the retained substance.

The content of the above present disclosure brings following beneficial effects. Firstly, the device for metal preparation by electro-reduction of molten salt provided in one or more embodiments of the present disclosure, the cathode of the molten salt electro-reduction reaction is the electrically conductive base plate of the reactor due to the conductivity of the base plate of the reactor and the insulation of the peripheral wall, and the base plate of the reactor is the conductive base plate of the reactor, and the barrel cavity of the reactor is lined with the reactant and the molten salt in sequence from bottom to top, and the reactant is contacted with only the electrically conductive base plate of the reactor. The reactant only contacts with the conductive base plate of the reactor, so that when the molten salt electro-reduction is carried out, the electrons move upward from the bottom, and the current is transmitted directionally, and the molten salt electro-reduction process is carried out gradually from the bottom to the top, forming a “resistive” reaction structure, which is able to enhance the efficiency of the utilization of the electric current. Secondly, the device for metal preparation by electro-reduction of molten salt provided in one or more embodiments of the present disclosure has a simple process when carrying out the molten salt electro-reduction reaction, does not need to consume a large amount of coke as a reductant and raw material or to consume a large amount of non-renewable coal resources, which will not produce a large amount of CO₂, toxic gas, and slag, so that it is less polluting to the environment, and is capable of realizing a high efficiency and low cost. It can realize high efficiency and low cost, and it can carry out molten salt electro-reduction at a low operating temperature, and it can prepare metal efficiently without relying on coke. Thirdly, the device for metal preparation by electro-reduction of molten salt provided in one or more embodiments of the present disclosure has a low operating temperature, which allows the molten salt electro-reduction process of the reactant to be realized in a low temperature range, and is conducive to reducing the energy consumption of the heating process.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic structural diagram illustrating a device for metal preparation by electro-reduction of molten salt according to some embodiments of the present disclosure;

FIG. 2 is a schematic diagram illustrating another structure of a device for metal preparation by electro-reduction of molten salt according to some embodiments of the present disclosure;

FIG. 3 is a schematic diagram illustrating a device for metal preparation by electro-reduction of molten salt according to some embodiments of the present disclosure;

FIG. 4 is a flowchart illustrating an exemplary process for metal preparation by electro-reduction of molten salt according to some embodiments of the present disclosure;

FIG. 5 is a photograph of an iron powder obtained by water washing of a prepared retained substance according to some embodiments of the present disclosure;

FIG. 6 is a photograph of an iron mass obtained by induction melting and heating of a prepared retained substance according to some embodiments of the present disclosure;

FIG. 7 is an XRD pattern of a metal after electro-reduction of molten salt according to some embodiments of the present disclosure;

FIG. 8 is another photograph of a metal obtained by electro-reduction of TiO₂ molten salt according to some embodiments of the present disclosure; and

FIG. 9 is another XRD pattern of a metal obtained by electro-reduction of molten salt according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “device,” “unit,” “module,” and/or “block” used herein are one method to distinguish different components, elements, parts, sections, or assemblies of different levels in ascending order. However, the terms may be displaced by other expressions if they may achieve the same purpose.

In the description of the embodiments of the present disclosure, it should be noted that the orientation or positional relationship indicated by the terms “center”, “upper”, “lower”, “left”, “right”, “vertical”, “horizontal”, “inside”, “outside”, etc., corresponds to the orientation or positional relationship shown in the accompanying drawings, which is only for the convenience of describing the embodiments of the present disclosure and simplifying the description, rather than indicating or implying that the device or element referred to must have a specific orientation or be constructed and operated in a specific orientation, and therefore cannot be understood as a limitation to the present disclosure. The terms “first”, “second”, and “third” are only used for descriptive purposes and cannot be understood as indicating or implying relative importance. In addition, the terms “installed” and “connected” should be understood in a broad sense, for example, it can be a fixed connection, a detachable connection, or connected Integrally; as another example, it can be a mechanical connection or an electrical connection; and as a further example, it can be directly connected, indirectly connected through an intermediate medium, or be the communication between two elements. For those skilled in the art, the specific meanings of the above terms in the embodiments of the present disclosure can be understood according to the specific circumstances.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

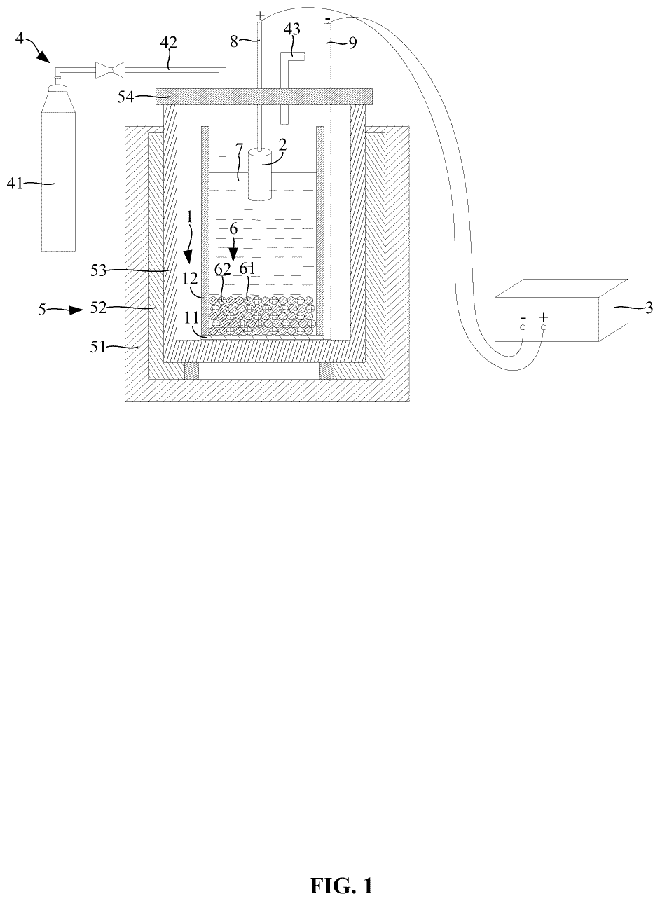

FIG. 1 is a schematic structural diagram illustrating a device for metal preparation by electro-reduction of molten salt according to some embodiments of the present disclosure. As shown in FIG. 1, the device for metal preparation by electro-reduction of molten salt includes a reactor 1, an electrical conductor 2, a power supply 3, a gas charging and discharging mechanism 4, and a closure mechanism 5.

The device for metal preparation by electro-reduction of molten salt is a device for metal preparation by molten salt electro-reduction reaction. The molten salt electro-reduction reaction is a metal preparation process in which a metal oxide is prepared to a metal by electro-reduction of a reactant in a molten state at a high temperature. The prepared metal may be a pure metal or an alloy.

The reactor 1 is used as a reaction vessel for metal preparation by electro-reduction of molten salt. In some embodiments, the reactor 1 may include a conductive portion and an insulating portion. For example, the conductive portion of the reactor 1 may include an electrically conductive base plate, a conductive barrel, or the like, and the insulating portion of the reactor 1 may include an insulating barrel body, or the like. In some embodiments, the barrel cavity of the reactor 1 may be filled with substances such as a reactant and a molten salt substance, to carry out a molten salt electro-reduction reaction.

In some embodiments, the reactor 1 is a barrel body with an electrically conductive base plate, an insulated peripheral wall, and an opening at one end, and the barrel cavity of the reactor 1 is configured for laying down a reactant 6 and a molten salt substance 7 sequentially from bottom to top. The base plate of the reactor 1 may be a metal such as stainless steel, iron, titanium and a conductive material such as graphite. The peripheral wall may be a high temperature resistant insulating material such as corundum, a magnesium oxide, or other materials. The molten salt substance 7 is used as an electrolyte for molten salt electro-reduction.

The electrical conductor 2 is a conductor that transmits electrical energy from the power supply 3 into the reactor 1 during the process of metal preparation by electro-reduction. In some embodiments, the electrical conductor 2 may be placed within the reactor 1, and the electrical conductor 2 may be inserted in the molten salt substance 7. In some embodiments, the electrical conductor 2 may include an electrode, such as a graphite electrode, a platinum electrode, or the like. In some embodiments, the electrical conductor 2 is used to be inserted into the melted molten salt substance 7. The shape of the electrical conductor 2 may be a column, a table, etc.

In some embodiments, a graphite rod may be employed as the electrical conductor 2. The rod-shaped outer wall is smooth, non-sticky material, and convenient for processing. Graphite has good electrical conductivity and good chemical stability and is stable to most acids. Graphite has small coefficient of linear expansion, small sensitivity to temperature changes, and high thermal stability, making it well resistant to thermal shock. The “affinity” between graphite and most of the media is very small, the surface of the graphite rod is not easy to scale and not easy to affect the conductivity. Graphite has a good processing performance, in addition to not being able to press and forge, it may be a variety of mechanical processing.

The power supply 3 is a device used to provide electrical power to the molten salt electro-reduction reaction taking place in the reactor 1. In some embodiments, the power supply 3 may include a DC power supply, an AC power supply, or the like.

In some embodiments, the power supply 3 may be a DC power supply, a positive pole of the power supply 3 is electrically connected to the electrical conductor 2, and a negative pole of the power supply 3 is electrically connected to the base plate, thereby providing electrical power for the molten salt electro-reduction reaction conducted within the reactor 1.

The gas charging and discharging mechanism 4 is a device for charging and discharging gas into the reactor 1. In some embodiments, the gas charging and discharging mechanism 4 may continuously charge a protective gas into the reactor 1 while discharging an exhaust gas generated in the reactor 1. The protective gas is a gas that provides an inert atmosphere to protect the metal during the metal preparation by electro-reduction. In some embodiments, the protective gas may include argon, helium, or the like, or any combination thereof.

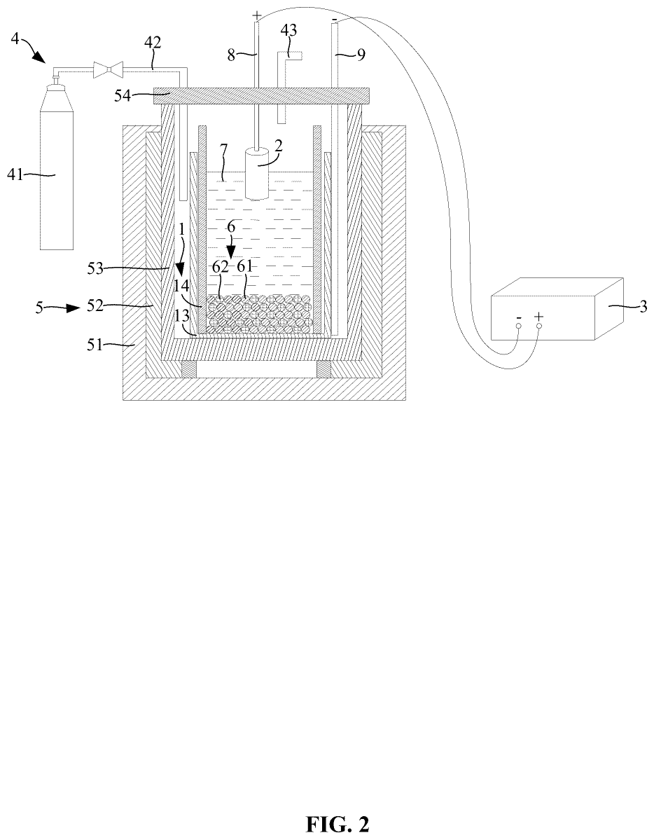

In some embodiments, the gas charging and discharging mechanism 4 includes a gas tank 41, a filling tube 42, and an exhausting tube 43, as shown in FIG. 1 and FIG. 2. One end of the filling tube 42 is connected to an output port of the gas tank 41, and the other end penetrates through a top cover of the closure mechanism 5 to extend into an interior of the closure mechanism 5 to continuously fill the protective gas into the reactor 1. The exhausting tube 43 is inserted in the top cover of the closure mechanism 5 for removing the exhaust gas. The gas charging and discharging mechanism 4 is charged with a protective gas according to the actual demand. For example, the protective gas charged in the present disclosure is argon, and the gas tank 41 is an argon tank.

The closure mechanism 5 is a device for accommodating the reactor 1, the electrical conductor 2, and other components of a device for metal preparation by electro-reduction of molten salt 310. By using the closure mechanism 5, it is possible to provide a hermetically sealed reaction environment for the molten salt electro-reduction reaction, which helps to thereby prevent the leakage of the exhaust gas during the reaction process and reduce the dissipation of heat, and to ensure the stability and safety of the reaction process.

In some embodiments, the reactor 1 and the electrical conductor 2 are provided inside the closure mechanism 5, and the power supply 3 is provided outside the closure mechanism 5.

In some embodiments, the closure mechanism 5 may include a heating furnace, etc., and the closure mechanism 5 may be other types of closures. When the closure mechanism 5 is a heating furnace, and the heating furnace includes a furnace shell 51, an insulation layer 52, a furnace chamber 53, and a furnace lid 54. The reactor 1 and the electrical conductor 2 are provided in an interior of the furnace chamber 53. When the closure mechanism 5 is a closure body, the components such as the reactor 1 and the electrical conductor 2 may be pre-installed, and when it is necessary to use the device, it is sufficient to place the device as a whole in the use occasion.

Some embodiments of the present disclosure provide a device for metal preparation by electro-reduction of molten salt, a reactant 6 and a molten salt substance 7 are laid down in a barrel cavity of the reactor 1 in sequence from bottom to top, the gas charging and discharging mechanism 4 and the closure mechanism 5 are mounted, the positive pole of the power supply 3 is electrically connected to the electrical conductor 2, and the negative pole of the power supply 3 is electrically connected to the base plate of the reactor 1. The reactor 1 is heated until the molten salt substance 7 melts and the electrical conductor 2 is inserted within the molten salt substance 7. The protective gas is continuously charged into the reactor 1 by the gas charging and discharging mechanism 4, while the exhaust gas is removed. The power supply 3 is switched on to perform the molten salt electro-reduction. When the reaction in the barrel cavity of the reactor 1 is finished, the power supply 3 is disconnected, the molten salt substance 7 in the upper portion of the barrel cavity is poured out, and the retained substance in the lower portion is taken out. Finally, the metal is obtained by the retained substance.

Some embodiments of the present disclosure provide a device for metal preparation by electro-reduction of molten salt, wherein the cathode for the molten salt electro-reduction reaction is the electrically conductive base plate of the reactor 1 due to the conductive base plate of the reactor 1 and the peripheral wall is insulated, wherein the barrel cavity of the reactor 1 is lined sequentially from the bottom up with the barrel cavity of the reactor 1 is lined from bottom to top with the reactant 6 and the molten salt substance 7, and the reactant 6 only contacts and conducts with the conductive base plate of the reactor 1, so that when the molten salt electro-reduction is carried out, the electrons move upward from the bottom, and the current is directed to be transmitted, and the molten salt electro-reduction process is carried out gradually from the bottom to the top to form a “resistive” reaction structure, which is able to enhance the efficiency of the utilization of the current. The device for metal preparation by electro-reduction of molten salt provided according to some embodiments of the present disclosure has a simple process when carrying out molten salt electro-reduction, and does not need to consume a large amount of non-renewable coal resources, nor does it produce a large amount of CO₂, toxic gas, and slag, so it is less polluting to the environment, and may realize high efficiency and low cost, and it may carry out molten salt electro-reduction at a low operating temperature, and it may efficiently prepare metals without relying on coke. The device has a low operating temperature, and the molten salt electro-reduction process of the reactant 6 may be realized in a low temperature range, which is conducive to reducing the energy consumption of the heating process.

As shown in FIG. 1, the reactor 1 includes a conductive base plate 11 and a first insulating cylinder 12, the first insulating cylinder 12 is disposed on the conductive base plate 11 to make the base plate of the reactor 1 electrically conductive and the peripheral wall insulated.

In some embodiments of the present disclosure, the structure of the reactor 1 is simple, and the reactor 1 has the advantage of easy to manufacture and use, and low cost.

In some embodiments, the outer diameter of the conductive base plate 11 is equal to or greater than the outer diameter of the first insulating cylinder 12, which ensures that the bottom of the barrel cavity of the reactor 1 is fully conductive to enable the device to perform a better effect when performing the molten salt electro-reduction. In addition, it is possible to facilitate the electrical connection of the conductive base plate 11 to the power supply 3.

In some embodiments, as shown in FIG. 1, when the reactor 1 includes the conductive base plate 11 and the first insulating cylinder 12, the gas charging and discharging mechanism 4 has a filling tube 42 extending into an upper portion of the barrel cavity of the reactor 1, and when the inflated protective gas (such as argon) is heavier than the mass of the exhaust gas, the protective gas continuously flows downward, and the exhaust gas in the barrel cavity may be more fully and quickly removed.

In some embodiments of the present disclosure, extending the gas filling tube 42 of the gas charging and discharging mechanism 4 above the barrel cavity of the reactor 1 helps to enable the protective gas to fill the barrel cavity of the reactor 1 more rapidly.

FIG. 2 is a schematic diagram illustrating another structure of a device for metal preparation by electro-reduction of molten salt according to some embodiments of the present disclosure. FIG. 2 shows a device for metal preparation by electro-reduction of molten salt, and structures of the electrical conductor 2, the power supply 3, the gas charging and discharging mechanism 4, the closure mechanism 5, a first conductive rod 8, and a second conductive rod 9 are the same as structures of those of the device shown in FIG. 1. The structure of the device for metal preparation by electro-reduction of molten salt is the same as that shown in FIG. 1. In some embodiments, the reactor 1 of the device for metal preparation by electro-reduction of molten salt shown in FIG. 2 includes a conductive barrel 13 and a second insulating cylinder 14. The second insulating cylinder 14 is inserted into the conductive barrel 13 and has a bottom surface against an inner bottom surface of the conductive barrel 13, wherein the bottom surface of the conductive barrel 13 acts as a conductive base plate of the reactor 1, and the second insulating cylinder 14 acts as an insulator of the peripheral wall of the reactor 1.

In some embodiments, when the reactor 1 includes the conductive barrel 13 and the second insulating cylinder 14, after the second insulating cylinder 14 is inserted into the conductive barrel 13, a height of the outer wall of the conductive barrel 13 is lower than the height of the second insulating cylinder 14, which may prevent the formation of an electrically isolated layer at the opening of the reactor 1, which affects the effect of the molten salt electro-reduction.

In some embodiments, taking the device for metal preparation by electro-reduction of molten salt shown in FIG. 2 as an example, when the reactor 1 include the conductive barrel 13 and the second insulating cylinder 14, as the conductive barrel 13 is set up, the filling tube 42 of the gas charging and discharging mechanism 4 extends into the gap between the inner cavity of the closure mechanism 5 and the conductive barrel 13, it is possible to facilitate the installation of the conductive barrel 13 and the second insulating cylinder 14 and their placement in the closure mechanism 5.

In some embodiments of the present disclosure, the structure of the reactor 1 is simple and easy to implement, and an existing graphite crucible may be utilized as the conductive barrel 13, which may save costs. The reactor 1 includes a conductive barrel 13, which is able to facilitate the negative pole of the power supply 3 to be electrically connected to the base plate of the reactor 1. Because the conductive barrel 13 is electrically conductive as a whole, the second insulating cylinder 14 is inserted inside the conductive barrel 13 so as to electrically connect the negative pole of the power supply 3 to the conductive barrel 13 at any position, and it is possible to realize that the negative pole of the power supply 3 and the reactor 1 electrically connected to the base plate of the reactor without affecting the insulation of the second insulating cylinder 14.

As shown in FIG. 1 and FIG. 2, the device for metal preparation by electro-reduction of molten salt further includes a first conductive rod 8. One end of the first conductive rod 8 is electrically connected to the electrical conductor 2, and the other end penetrates the closure mechanism 5 to be electrically connected to the positive pole of the power supply 3. The first conductive rod 8 may be a steel rod.

In some embodiments, since the electrical conductor 2 is used to insert the molten salt substance 7 after melting, the first conductive rod 8 is used to connect with the electrical conductor 2 at one end and the other end of the first conductive rod 8 is connected to the positive pole of the power supply 3 by means of the closure mechanism 5, i.e., the first conductive rod 8 is provided on the top cover of the closure mechanism 5. That is, the first conductive rod 8 is set on the top cover of the closure mechanism 5, which may conveniently fix the electrical conductor 2 to not easily fall off, and at the same time, it is convenient to determine the relative position of the electrical conductor 2 and the molten salt substance 7, and it does not affect the electrical connection between the electrical conductor 2 and the power supply 3.

In some embodiments, it is also possible to electrically connect the electrical conductor 2 to the power supply 3 directly via a wire.

In some embodiments, the device for metal preparation by electro-reduction of molten salt further include a second conductive rod 9. The second conductive rod 9 may be a steel rod. One end of the second conductive rod 9 is electrically connected to the base plate of the reactor 1, and the other end penetrates the closure mechanism 5 to be electrically connected to the negative pole of the power supply 3. The setting of the second conductive rod 9 may facilitate the negative pole of the power supply 3 to be electrically connected to the base plate, and the rod shape is fixed for better setting and installation. The reactor 1 includes a conductive base plate 11 and a first insulating cylinder 12, an outer diameter of the conductive base plate 11 is equal to or greater than an outer diameter of the first insulating cylinder 12, and it is possible to facilitate the second conductive rod 9 to be electrically connected to the conductive base plate 11, simply by connecting the conductive base plate 11 with the negative pole of the power supply 3. The second conductive rod 9 may be electrically connected to the conductive base plate 11 by simply contacting the outer edge of the conductive base plate 11 with the second conductive rod 9. The second insulating cylinder 14 is provided to ensure that a peripheral wall of the reactor 1 remains insulated after the second conductive rod 9 is installed. Of course, it is also possible to electrically connect the electrical conductor 2 to the power supply 3 via a wire. In addition, since the device needs to be heated to carry out the molten salt electro-reduction, the first conductive rod 8 and the second conductive rod 9 may be heat-resistant.

In some embodiments of the present disclosure, using a steel rod as the second conductive rod may effectively reduce the expense consumption of the second conductive rod due to the readily available and low cost of the steel rod material.

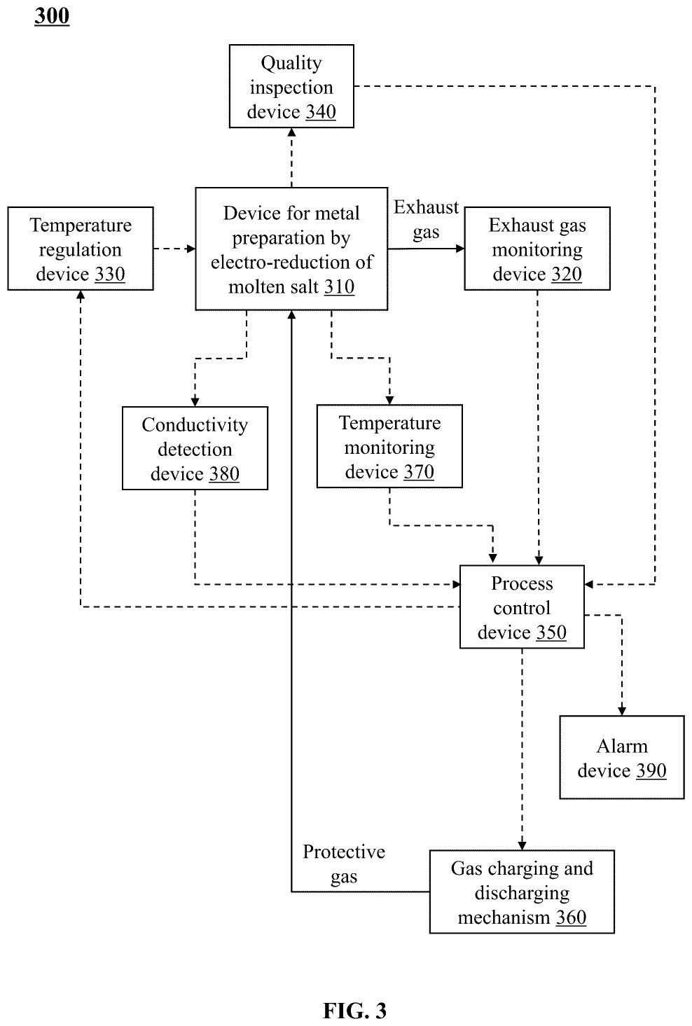

FIG. 3 is a schematic diagram illustrating a device for metal preparation by electro-reduction of molten salt according to some embodiments of the present disclosure. In some embodiments, as shown in FIG. 3, the device for metal preparation by electro-reduction of molten salt 310 may further include an exhaust gas monitoring device 320, a temperature regulation device 330, a quality inspection device 340, process control device 350, a temperature monitoring device 370, a conductivity detection device 380, and an alarm device 390.

In some embodiments, the device for metal preparation by electro-reduction of molten salt 310 further includes the exhaust gas monitoring device 320, the exhaust gas monitoring device 320 is used to obtain an exhaust gas and to analyze the exhaust gas for composition and to obtain an exhaust gas composition result based on reduction reaction parameters.

The exhaust gas monitoring device 320 is a device for detecting and analyzing an exhaust gas generated during a molten salt electro-reduction reaction. In some embodiments, since the exhaust gas including different gas products is usually generated during the process of molten salt electro-reduction for metal preparation, monitoring and analyzing the different types of gas products may help to sense whether the reaction situation of metal reduction and preparation is as required. By monitoring and analyzing the different types of gas products, it helps to sense whether the reaction condition of the metal reduction preparation is in accordance with the requirements, and make timely adjustments to the reduction parameters. In some embodiments, the exhaust gas monitoring device 320 may be disposed at the exhausting tube 43 of the device for metal preparation by electro-reduction of molten salt 310. More on the reduction parameters may be found in the related description below.

In some embodiments, since multiple chemical reactions typically occur during the preparation process of molten salt electro-metallic reduction, the type and the content of the exhaust gas produced in the different chemical reactions may vary. Therefore, the exhaust gas composition result may be obtained by analyzing the exhaust gas composition through the exhaust gas monitoring device 320 and determining the reduction parameters of the subsequent production process through the exhaust gas composition result.

In some embodiments, the exhaust gas monitoring device 320 may include different types of gas sensors. For example, the exhaust gas monitoring device 320 may include one or more of an oxide sensor, a sulfide sensor, a nitrogen oxide sensor, a carbon monoxide sensor, or the like.

The exhaust gas composition analysis is an analytical process for obtaining the different types of gas products in the exhaust gas and their percentage share, and the exhaust gas composition result may reflect the nature characteristics of the exhaust gas produced by the molten salt electro-reduction reaction.

In some embodiments, the exhaust gas composition result may include a composition and a mass of a gas product. The gas product is a gas produced in a molten salt electro-reduction reaction. For example, the exhaust gas composition result may be expressed as (carbon monoxide 5%, carbon dioxide 80%, nitrogen dioxide 20%).

In some embodiments, the exhaust gas monitoring device 320 may obtain, based on the gas sensors of the exhaust gas monitoring device 320, a composition of the gas products contained in the exhaust gas and a mass corresponding to each gas product as an initial exhaust gas composition result.

In some embodiments, the exhaust gas monitoring device 320 may process the initial composition results based on the reduction reaction parameters to obtain a desired exhaust gas composition result.

The reduction reaction parameter is a transformation relationship between a reaction raw material and a reaction product that may reflect the process of metal preparation by molten salt electro-reduction. In some embodiments, the reduction reaction parameter may be expressed as a reaction equation for the reaction and side reactions that may occur during the molten salt electro-reduction reaction, each reaction equation contains a transformational relationship between the reactants and the products (e.g., the types and quantities of the reactants and the types and quantities of the products) and reaction conditions (e.g., the reaction temperatures, the reaction times, etc.) necessary for the reaction to proceed. Information. According to the reduction reaction parameter, the count of reactions and the types of by-products during the reaction may be determined. The reduction reaction parameter may be obtained based on querying relevant reaction data for the molten salt electro-reduction reaction.

In some embodiments, the exhaust gas monitoring device 320 may screen the gas product components in the initial composition result based on the reduction reaction parameters, exclude the gas product components corresponding to the irrelevant gas (such as the protective gas). The exhaust gas monitoring device 320 may retain only the gas product components in the initial composition result related to the gas products associated with the molten salt electro-reduction reaction. The exhaust gas monitoring device 320 may determine the screened gas products and the corresponding mass as the desired exhaust gas composition result.

For example, when the gas products in the initial composition result include gas A, gas B, gas C, and gas D, and when the reduction reaction parameter indicates that gas D is not likely to be produced by the current molten salt electro-reduction reaction (e.g., gas D is a protective gas), the exhaust gas monitoring device 320 may retain only gas A, gas B, and gas C in the initial composition result as the exhaust gas composition result.

In some embodiments of the present disclosure, the exhaust gas discharged from the device for metal preparation by electro-reduction of molten salt 310 contains not only gas products due to the molten salt electro-reduction reaction, but also irrelevant gas such as protective gas. Thus, analyzing the exhaust gas composition may help to exclude the interference of irrelevant gas, such as protective gas, and thereby obtain more accurate exhaust gas composition results.

In some embodiments, the device for metal preparation by electro-reduction of molten salt 310 further includes the temperature regulation device 330 and the quality inspection device 340, the temperature regulation device 330 is configured to regulate the temperature within the reactor 1; and the quality inspection device 340 is located at a bottom of the reactor 1 for detecting the mass within the reactor 1.

The temperature regulation device 330 is a device for adjusting the temperature of the reactor 1 within device for metal preparation by electro-reduction of molten salt 310. In some embodiments, the temperature regulation device 330 may include devices such as heaters and/or coolers. The temperature regulation device 330 may be connected in communication with to the process control device 350 to receive a temperature regulator parameter sent by the process control device 350 and to adjust the temperature of the reactor 1.

The temperature regulator parameter is a parameter instruction for controlling the temperature regulation device 330 for heating or cooling. In some embodiments, the temperature regulator parameter may include the need to heat or cool the reactor 1 and the corresponding temperature adjustment magnitude, e.g., 50° C. for ramping up, 100° C. for cooling down, and so on. In some embodiments, the regulation instruction may include a target reactor temperature which is needed to be reached by the reactor 1 within the device for metal preparation by electro-reduction of molten salt 310.

In some embodiments, the process control device 350 may determine the temperature regulator parameter in multiple ways. For example, the process control device 350 may determine a reaction temperature required for a current molten salt electro-reduction reaction based on the reduction reaction parameters, determining that reaction temperature as the target reactor temperature. More on the reduction reaction parameter may be found in the related description above.

In some embodiments, the process control device 350 may determine the temperature regulator parameters based on any other feasible means. A description of the molten salt substance characterization and more processes for determining the temperature regulator parameters may be found below.

The quality inspection device is a device for determining a total mass of the filled feedstock within the reactor 1. The filled feedstock within the reactor 1 includes a reactant, a molten salt substance, or the like. In some embodiments, the quality inspection device 340 may be a device such as an electronic scale. The quality inspection device 340 may be mounted at the bottom of the reactor 1,

In some embodiments, the quality inspection device 340 may obtain a total mass of the reactor 1 as a whole, and subtracting a self-weight of the reactor 1 from the total mass of the reactor 1 as a whole to obtain the total mass of the filled feedstock within the reactor 1. The self-weight of the reactor 1 may be obtained based on, for example, a factory report of the reactor 1.

In some embodiments, the quality inspection device 340 may be connected in communication with the process control device 350 to send the total mass of the filled feedstock within the reactor 1 to the process control device 350. The process control device 350 may determine information such as the experimental advancement of the current reaction based on the total mass of the filled feedstock within the reactor 1 and the reduction reaction parameters obtained by the quality inspection device 340. More on the introduction of experimental advancement and a process for determining the experimental advancement may be found below.

In some embodiments of the present disclosure, the melting temperature of the molten salt substance varies due to the different composition and percentage of molten salt substance used in different molten salt electro-reduction reactions. Determining a target reactor temperature based on the melting molten salt substance features ensures that the target reactor temperature is sufficient to melt the molten salt substance while minimizing unnecessary heat consumption.

In some embodiments, the device for metal preparation by electro-reduction of molten salt 310 further include the process control device 350.

The process control device 350 is configured as a device that orchestrates and coordinates the transfer of information and collaboration between the devices and provides control management functions for the device for metal preparation by electro-reduction of molten salt 310.

In some embodiments, the process control device 350 may include, but is not limited to, a central processing unit (CPU), a field programmable gate array (FPGA), or the like. The process control device 350 is configured to orchestrate, coordinate information transfer and collaboration between units, and provide control management functions for the device for metal preparation by electro-reduction of molten salt 310. More about the process control device 350 may be found in the related description below.

In some embodiments, the process control device 350 may determine a reduction parameter, the reduction parameter including a gas charging and discharging rate, a temperature regulator parameter, and a power supply current magnitude. The process control device 350 may send the gas charging and discharging rate to the gas charging and discharging mechanism 4 and send the temperature regulator parameter to the temperature regulation device. The process control device 350 may control the power supply current output according to the power supply current magnitude.

The reduction parameter is a relevant parameter used to modulate the molten salt electro-reduction reaction. In some embodiments, the reduction parameter may include a gas charging and discharging rate, a temperature regulator parameter, and a power supply current magnitude. The gas charging and discharging rate refers to a rate at which the gas charging and discharging mechanism delivers the protective gas into the reactor 1, the power supply current magnitude refers to a magnitude of the current supplied by the power supply 3 during the molten salt electro-reduction reaction, and more description of the temperature regulator parameter may be found above.

In some embodiments, different reduction parameters may have different effects on the molten salt electro-reduction reaction. For example, when the gas charging and discharging rate is too slow, it may not be able to efficiently remove the residual oxygen and moisture in the reactor 1, resulting in the molten salt substance and/or the reactant being exposed to an oxidizing atmosphere; and when the gas charging and discharging rate is too fast, which may cause violent stirring of the surface layer of the molten salt liquid, affecting the stable progress of the reaction. When the temperature regulator parameter is too high, a side reaction may be triggered, or the molten salt substance may decompose or volatilize, affecting the purity of the final product and posing a safety hazard; and when the temperature regulator parameter is too low, the molten salt substance may solidify, thereby reducing or even terminating the reaction. When the power supply current is too large, it may lead to problems such as polarization of the electrodes, which may affect the purity of the final product and reduce the life of the electrodes; when the power supply current is too small, it may lead to a longer elapsed time of the molten salt electro-reduction reaction. Therefore, it is necessary to determine a more appropriate reduction parameter to achieve a balance between the efficiency of the molten salt electro-reduction reaction and the purity of the product.

In some embodiments, the process control device 350 may determine the reduction parameter in multiple ways. In some embodiments, the process control device 350 may determine a default set values of the gas charging and discharging rate, the temperature regulator parameter, and the power supply current magnitude as the reduction parameter. The default set values for the gas charging and discharging rate, the temperature regulator parameters, and the power supply current magnitude may be preset values of the gas charging and discharging mechanism, the temperature regulation device, and the power supply 3 as shipped from the factory.

In some embodiments, the process control device 350 may determine the reduction parameter based on a reactant feature, a molten salt substance feature, and a reduction reaction parameter.

The reactant feature may reflect the components contained in the reactant and the percentage of each component. The molten salt substance feature may reflect the components contained in the molten salt substance and the percentage of each component. In some embodiments, the reactant feature and the molten salt substance feature may be obtained based on information such as a production schedule.

In some embodiments, the process control device 350 may determine the reduction parameters based on the reactant feature, the molten salt substance feature, and the reduction reaction parameters, in various ways. For example, the process control device 350 may obtain a plurality of sets of historical reaction records of the molten salt electro-reduction metal preparation and historical quality control reports corresponding to the historical reaction records, and the process control device 350 may screen the historical reaction records based on the historical quality inspection reports, and determine qualified historical reaction records and historical reduction parameters corresponding to the qualified historical reaction records as sample reaction records and corresponding sample reduction parameters. For example, the qualified historical reaction records indicate that the purity of the final product is greater than a preset purity threshold. The historical reaction record may include a historical reactant feature, a historical molten salt substance feature, and a historical reduction parameter.

In some embodiments, the process control device 350 may establish a second preset table based on the sample response records with corresponding sample reduction parameters. The second preset table includes a correspondence between the sample reaction records and the different sample reduction parameters. The process control device 350 may determine the current reduction parameter by consulting the second preset table based on the current reactant feature, the molten salt substance feature, and the reduction reaction parameter.

In some embodiments, when the second preset table has a plurality of sets of data with the same sample response record but different sample reduction parameters, the process control device 350 may select the sample reduction parameter that appears the most frequently as the sample response record.

In some embodiments of the present disclosure, by obtaining and filtering a number of sets of historical reaction records of molten salt electro-reduction metal preparations and corresponding historical quality inspection reports, it can be ensured that when using the historical reaction records for determining the reduction parameters, the historical reaction records can be screened out in advance of the historical reaction records with poorer effects and retain only the historical reaction records with better effects, which helps to ensure the actual use of the reduction parameters.

In some embodiments, the process control device 350 may periodically update the reduction parameters. The periodic updating of the reduction parameters includes: determining a reduction parameter for a current cycle based on a mass sequence within the reactor 1 of the current cycle, a monitoring data sequence of the current cycle, the compositional result sequence of the current cycle, the current cycle, the reduction parameters of the current cycle, and determining the reduction parameters for a next cycle using a reduction parameter prediction model; the reduction parameter prediction model is a machine learning model.

A period is a time period for updating the reduction parameters. In some embodiments, different reduction parameters may be employed at different time cycles during the reaction process of molten salt electro-metallic reduction. A cycle length may be determined based on actual application scenarios and needs.

In some embodiments, the cycle length may also be related to an experimental complexity, and the experimental complexity is determined based on the reduction reaction parameters.

The experimental complexity reflects a complexity of the molten salt electro-reduction reaction. The experimental complexity may be expressed numerically. In some embodiments, the experimental complexity may be determined based on reduction reaction parameters. For example, the experimental complexity may be positively correlated to the number of reaction equations in the reduction reaction parameters, and the type of by-products, among other things. The greater the count of reaction equations and the greater the count of types of by-products, the more complex the molten salt electro-reduction reaction is and the greater the value of the experimental complexity. More on the reduction reaction parameters may be found in the related note above.

In some embodiments, the cycle length may be negatively correlated to the experimental complexity. Understandably, the greater the experimental complexity, the greater the count of variable factors and the greater the uncertainty in the molten salt electro-reduction reaction process, and in order to regulate the molten salt electro-reduction reaction in a timely manner, the cycle length needs to be appropriately reduced to frequently update the reduction reaction parameters.

In some embodiments of the present disclosure, for the molten salt electro-reduction reaction of less experimental complexity, the cycle length may be appropriately prolonged to economize on arithmetic power due to fewer interfering factors in the reaction and a simpler reaction. For the molten salt electro-reduction reaction of greater experimental complexity, due to the more interfering factors in the reaction and the reaction is more complex, with more uncontrollable factors, the cycle length may be reduced and extended to enable timely adjustment of the device for metal preparation by electro-reduction of molten salt. This allows flexible adjustment of the cycle length.

The reduction parameter prediction model is a prediction model for predicting a reduction parameter. In some embodiments, the reduction parameter prediction model may be a machine learning model. For example, the reduction parameter prediction model may be any one or a combination of neural network (NN) models or other customized model structures.

In some embodiments, inputs to the reduction parameter prediction model include a mass sequence of the current cycle, a temperature monitoring data sequence of the current cycle, a compositional result sequence of the current cycle, and reduction parameters of the current cycle, and outputs of the reduction parameter prediction model include reduction parameters for the next cycle. The mass sequence is a sequence consisting of masses of the filled feedstock within the reactor 1 at different points in time. The temperature monitoring data sequence is a sequence including temperatures of the molten salt substance within the reactor 1 at different points in time. The compositional result sequence is a sequence including the exhaust gas composition result at different points in time of the exhaust gas generated by the device for metal preparation by electro-reduction of molten salt 310.

More about the temperature monitoring device and the temperature monitoring data sequence may be found in the description below. More on the reduction parameters may be found above.

The reduction parameter prediction model may be obtained by training. In some embodiments, the process control device 350 may train the reduction parameter prediction model based on a large number of first training samples with a first label. In some embodiments, the process control device 350 may obtain a plurality of sets of historical reaction records with historical quality control reports, and filter the historical reaction records based on the historical quality control reports, and evaluated historical reaction records are determined as the sample reaction records. The process control device 350 may acquire a historical mass sequence, a historical temperature monitoring data sequence, a historical compositional result sequence, and a historical reduction parameter of a first historical cycle corresponding to the sample reaction record as the first training sample. The process control device 350 may use the historical reduction parameters of the second historical cycle corresponding to the sample response record as the first label. The second history cycle is adjacent to and the second history cycle is later than the first history cycle.

In some embodiments, the process control device 350 may be trained by various manners based on the first training samples and the first label. For example, training may be performed based on a gradient descent manner. Merely by way of example, a plurality of first training samples with the first label may be input into an initial reduction parameter prediction model, a loss function may be constructed from the first label and the results of the initial reduction parameter prediction model, and a loss function may be built based on the loss function iteratively updating parameters of the initial reduction parameter prediction model. The model training is completed when the loss function of the initial reduction parameter prediction model satisfies a preset condition, and the trained reduction parameter prediction model is obtained. The preset condition may be that the loss function converges, the number of iterations reaches a threshold, and so on.

In some embodiments of the present disclosure, the process of the molten salt electro-reduction reaction can be regulated in a timely manner by determining the reduction parameters by the process control device 350, which helps to achieve a balance.

In some embodiments, the device for metal preparation by electro-reduction of molten salt 310 further include at least one temperature monitoring device 370 and a conductivity detection device 380, the temperature monitoring device 370 is disposed at a preset position in the reactor 1 for obtaining temperature monitoring data; and the conductivity detection device 380 is located on the inner wall of the reactor 1 for detecting the electrical conductivity of the molten salt substance in the reactor 1.

The temperature monitoring device 370 is a device for obtaining temperature monitoring data of a molten salt substance in the reactor 1. The temperature monitoring device 370 may be connected in communication with the process control device 350 to send the temperature monitoring data to the process control device 350. In some embodiments, the temperature monitoring device 370 may include at least one temperature sensor, e.g., a thermocouple sensor, an infrared temperature sensor, or the like.

In some embodiments, the temperature sensor may be disposed at a preset position of the reactor 1 to obtain temperature monitoring data of the molten salt substance at the preset position. The preset position may be determined according to actual application scenarios and needs, for example, the preset position may be a position inside the first insulating cylinder or inside the second insulating cylinder.

The electrical conductivity detection device 380 is a device for measuring the electrical conductivity of a molten salt substance within the reactor 1. The conductivity detection device 380 may be connected in communication with the process control device 350 to send conductivity properties (e.g., conductivity) to the process control device 350. In some embodiments, the conductivity detection device 380 may include components such as an electrical conductivity meter, electrodes, or the like, and the electrical conductivity of the molten salt substance is detected by inserting an electrode electrically connected to the electrical conductivity meter into the molten salt within the reactor 1.

In some embodiments, the process control device 350 is further used to: determine a melting degree of the molten salt substance based on the temperature monitoring data of the at least one temperature monitoring device 370 and the electrical conductivity of the conductivity detection device 380, and in response to the melting degree of the molten salt substance reaching a melting degree preset value, insert the electrical conductor 2.

The melting degree of the molten salt substance may reflect the melting of the molten salt substance. In some embodiments, the melting degree of the molten salt substance melting may be expressed as a percentage. For example, 30% indicates that 30% of the molten salt substance is liquid. As another example, 100% indicates that all of the molten salt substance is melted.

In some embodiments, since the electrical conductivity of the melted molten salt substance is typically higher than the electrical conductivity of the unmelted molten salt substance, the process control device 350 may determine the melting degree of the molten salt substance based on the temperature monitoring data and the electrical conductivity.

In some embodiments, when the temperature monitoring data of the at least one temperature monitoring device are all higher than the melting point temperature of the molten salt substance and the electrical conductivity is greater than the melting point conductivity, the molten salt substance melting may be 100%, i.e., all of the molten salt substance melts.

In some embodiments, when the temperature monitoring data and the electrical conductivity do not satisfy the requirement of 100% melting degree of the molten salt substance as described above, the process control device 350 may construct, based on a plurality of sets of historical reaction records of the molten salt electro-reduction metal preparations, a vector database to determine the corresponding melting degree of the molten salt substance based on matching vector retrieval.

In some embodiments, the process control device 350 may construct a target feature vector based on the at least one temperature monitoring data and the electrical conductivity. There may be various ways to construct the target feature vector. For example, target feature vectors are constructed by manners such as TF-IDF (Term Frequency-Inverse Document Frequency), One-Hot, Word2Vec, and so on.

The vector database may include a plurality of reference vectors and reference melting degree of the molten salt substances corresponding to the plurality of reference vectors. Each reference vector may be constructed based on historical temperature monitoring data and historical electrical conductivity. The reference vectors are constructed as the target feature vectors in a similar manner. The reference melting degree of the molten salt substance may be the historical actual measured melting degree of the molten salt substance. For example, the unmelted molten salt substance in the reactor 1 may be salvaged and weighed, and the actual melting degree of the molten salt substance may be calculated and used as the reference melting degree of the molten salt substance.

In some embodiments, the process control device 350 may determine a target control parameter based on a similarity between a target feature vector and a plurality of reference vectors in a vector database. For example, the reference vectors whose similarities with the target feature vectors satisfy a similarity preset condition are used as the target vectors, and the reference melting degree of the molten salt substance corresponding to the target vectors is used as the currently desired melting degree of the molten salt substance. The similarity preset condition may be set as appropriate. For example, the similarity is maximum, or the similarity is greater than a threshold, etc.

The melting degree preset value is a threshold value for determining whether the melting degree of the molten salt substance meets the requirement. In some embodiments, responsive to the molten salt substance melting to the melting degree preset value, the process control device 350 may control the insertion of the electrical conductor 2 into the melted molten salt substance. The melting degree preset value may be determined based on actual application scenarios and needs, such as 95%, etc. When the molten salt electro-reduction preparation reaction requires the molten salt substance to be completely melted, the melting degree preset value may be 100%.

In some embodiments of the present disclosure, the reaction condition within the reactor 1 may be examined more comprehensively by providing the temperature monitoring device 370 and the electrical conductivity detection device 380. In response to the melting degree of the molten salt substance reaching the melting degree preset value, the electric conductor 2 is inserted into the molten salt, which ensures that the molten salt substance has melted at this time, thus avoiding a situation where the electric conductor 2 is damaged or malfunctioned due to excessive resistance when being inserted due to the insufficient melting state of the molten salt substance.

In some embodiments, the device for metal preparation by electro-reduction of molten salt 310 further includes the alarm device 390.

The alarm device 390 is a device for issuing an alarm or notification when a preset alarm condition is met. In some embodiments, the alarm device 390 may include, but is not limited to, a buzzer, a light flasher, etc. Response to receiving an alarm instruction sent by the process control device 350, the alarm device 390 may perform an alarm operation such as a buzzer, a light blinker, or the like, to timely alert the relevant personnel to carry out subsequent operations such as an inspection of an abnormal situation.

In some embodiments, the process control device 350 is further used for determining a target model; predicting a preset melting time point by the target model; the preset melting time point being a time point at which the melting degree of the molten salt substance reaches a preset value, and in response to a current time and the predicted melting time point satisfy a preset alarm condition, triggering an alarm instruction and send the alarm instruction to the alarm device 390 for alarming.

The target model is a predictive model for predicting an estimated melting time point. In some embodiments, the target model may include a first target model and a second target model. The first target model and the second target model may be a machine learning model. For example, any one or a combination of Neural Network (NN) models or other customized model structures.

The first target model and the second target model serve the same purpose of predicting the predicted melting time point. Differently, the first target model is suitable for the case when the prediction accuracy of the predicted melting time point is required to be high and the experimental advancement is above a threshold value of the experimental advancement, and the second target model is suitable for the prediction of the predicted melting time point speed requirement is high and the experimental advancement is lower than the experimental advancement threshold. In some embodiments, the process control device 350 may also select the first target model or the second target model for predicting the predicted melting time point according to the actual need.

An experimental advancement degree may reflect the extent to which the molten salt electro-reduction reaction is proceeding. The experimental advancement degree may be expressed as a percentage, such as 50%, indicating that the molten salt electro-reduction reaction is halfway through. The process control device 350 may determine the experimental advancement degree based on the current reaction progress duration and the total current reaction duration. The total current reaction duration may be obtained based on production process planning, historical data, or the like.

In some embodiments, the process control device 350 may determine, based on the reduction reaction parameter, the total mass of the filled feedstock corresponding to different experimental advancement, by the quality inspection device 340 obtaining the total mass of the filled feedstock in the current reactor 1. The total mass of the current filled feedstock is compared to the total mass of the filled feedstock corresponding to the different degrees of experimental advancement, thereby determining the experimental advancement degree of the current reaction. For example, for a molten salt electro-reduction reaction in which the total mass of the filled feedstock is M at the beginning of the reaction and the total mass of the filled feedstock is M−100*N at the end of the reaction, and when the total mass of the filled feedstock is M−40*N indicating that the reaction has proceeded 40%, the experimental advancement is 40%.

The advancement threshold is a judgment threshold for determining whether to use the first target model or the second target model, and in some embodiments, the advancement threshold may be negatively correlated to experimental complexity. For example, the greater the experimental complexity, the more complex the experiment, and more necessary to adopt the more accurate target model for prediction, and the advancement threshold may be appropriately lowered, so that the process control device 350 is more inclined to select the first target model. When the experimental complexity is smaller, the advancement threshold may therefore be appropriately lowered so that the process control device 350 is more inclined to select a second target model that is faster to predict.

In some embodiments, inputs to the first target model include a sequence of melting degree of the molten salt substance over a preset time period, at least one temperature monitoring data over the preset time period, a current time point, and outputs of the first target model include a preset melting time point.

In some embodiments, inputs to the second target model include at least one piece of temperature monitoring data during a preset time period, an electrical conductivity during the preset time period, a current time point, and outputs of the second target model include a preset melting time point.

The predicted melting time point is a time point when the melting degree of the molten salt substance is predicted to reach the melting degree preset value, e.g., the time point time after 10 h. More about the melting degree sequence of the molten salt substance, the temperature monitoring data, and the electrical conductivity may be found in the related description above.

In some embodiments, a time range of the preset time period may be determined based on actual application scenarios and needs. For example, the preset time period may be the first 1 h of the current time point, the first 15 min, and so on.

In some embodiments, the process control device 350 may train the first target model based on a large number of second training samples with second labels. The second training samples may include at least one piece of sample temperature monitoring data during a first time period, a sample electrical conductivity during the first time period, and a second time point. The second label may be a third time point corresponding to the second sample. The first time period is the historical time period, the second time point is the time point at the very end of the first time period, and the third time point is later than the second time point.

In some embodiments, the second training sample may be obtained based on historical data, and the second label may be an actual melting time point of the molten salt substance in the historical data.

In some embodiments, the process control device 350 may train the second target model based on a large number of third training samples with a third label. The third training samples may include at least one sample temperature monitoring data during the first time period, a sample electrical conductivity during the first time period, and the second time point. The third label may be a third time point corresponding to the third sample. The first time period is the historical time period, the second time point is the time point at the very end of the first time period, and the third time point is later than the second time point.

In some embodiments, the third training sample may be obtained based on historical data, and the third label may be a time point based on actual melting of the molten salt substance in the historical data.

In some embodiments, the first target model and the second target model may be acquired by separate training. The operation for training the first target model and the second target model are the same as the process of training to obtain a reduction parameter prediction model, and may be found in the above description of training to obtain a reduction parameter prediction model based on many first training samples with first label above.

In some embodiments, the process control device 350 may, in response to the current melting duration meeting a preset alarm condition with a preset melting time point, trigger an alarm instruction and send the alarm instruction to the alarm device 390 for alarming.

The preset alarm condition is a judgment condition for determining whether an emergency has occurred that requires an alarm. In some embodiments, the preset alarm condition may be determined based on actual application scenarios and needs. For example, the preset alarm condition may be that the current time has exceeded the preset melting time point, and that the current time has exceeded the preset melting time point for a time period that is longer than a preset duration threshold.

In some embodiments of the present disclosure, by using a target model to determine a preset melting time and triggering an alarm instruction when a preset alarm condition is satisfied, it can be ensured that relevant personnel can be timely alerted to carry out, safety warnings, problem troubleshooting and other subsequent operations, so that the safety and reliability of the device for metal preparation by electro-reduction of molten salt 310 can be fully guaranteed in the process of using the device.

It is to be noted that the above description of the device for metal preparation by electro-reduction of molten salt 310, and the other devices, is provided only for descriptive convenience, and does not limit the present disclosure to the scope of the embodiments cited. It is to be understood that, for those skilled in the art, with an understanding of the principle of the system, it may be possible to arbitrarily combine modules or form subsystems to be connected to other modules without departing from this principle. In some embodiments, the device for metal preparation by electro-reduction of molten salt 310 disclosed in FIG. 3, the exhaust gas monitoring device 320, the temperature regulation device 330, the quality detection device 340, the process control device 350, the temperature monitoring device 370, and electrical conductivity detection device 380, and alarm device 390 may be different devices within a single device, or a single device may realize the functions of two or more of the above-described devices. For example, the individual devices may share a common storage module, and the individual devices may each have their own storage module. Morphisms such as these are within the scope of protection of The present disclosure.

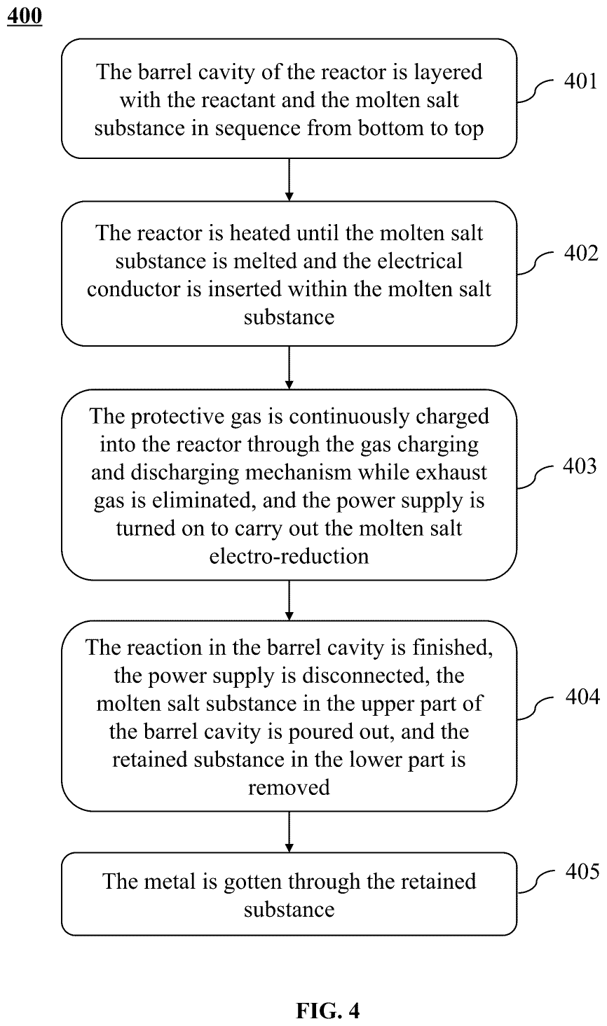

FIG. 4 is a flowchart illustrating an exemplary process for metal preparation by electro-reduction of molten salt according to some embodiments of the present disclosure. As shown in FIG. 4, process 400 includes operations 401 to 405. In some embodiments, the process 400 may use the device for metal preparation by electro-reduction of molten salt 310 described above.

In 401, the barrel cavity of the reactor is layered with the reactant and the molten salt substance in sequence from bottom to top.

In some embodiments, the molten salt substance 7 is one or more of chloride or fluoride. For example, the molten salt substance 7 is a combination of the chloride and fluoride.

In some embodiments, the molten salt substance 7 may include one or more of NaCl, KCl, CaCl₂, NaF, KF, CaF₂, or the like.

In some embodiments of the present disclosure, by using an electrolyte as the molten salt mixture, the eutectic temperature of the molten salt substance 7 may be lowered, and the temperature required to heat the molten salt substance 7 in the molten salt electro-reduction process of the device is lowered, and it is possible to realize that the molten salt substance 7 is electrically reduced in a temperature interval of 600° C. to 1200° C.

In some embodiments, the reactant 6 includes a metal oxide 61 and a conductive agent 62. The conductive agent 62 is a portion of the compositions of the prepared metal, such that when the reaction of the reactant 6 is complete, there is no need to additionally remove the conductive agent 62, which also becomes the prepared metal.

The metal oxide is a feedstock for molten salt electro-reduction reactions. In some embodiments, the metal oxide may include a single metal oxide of a metal, or a compound of a plurality of metal oxides. For example, when the device for metal preparation by electro-reduction of molten salt 310 entails the preparation of metallic iron, the metal oxide may include one or more of Fe₃O₄ or Fe₂O₃.

The conductive agent is an additive for the molten salt electro-reduction reaction, which acts as a conductive medium and an inductive medium for the metal oxide 61 during the molten salt electro-reduction process. In some embodiments, the conductive agent 62 is doped between powder particles of the metal oxide 61, such that the conductive agent 62 acts as a conductive medium and an inductive medium homogeneously distributed between the powder particles of the metal oxide 61. The electrically conductive agent 62 may be used to provide auxiliary internal heating when inductively heating the device. The metal oxide 61 in the reactant 6 is in the form of a powder that may be subjected to molten salt electro-reduction without the need for a press sample, shortening the time for metal preparation, and the metal oxide 61 has a large specific surface area for a fast reaction rate.

In some embodiments, the electrically conductive agent may include a carbon powder and/or a metal powder. For example, the conductive agent 62 may be a variety of biomass carbon powders and metal powders such as Al, Fe, Ti, or the like. For example, the mixture of the metal oxide 61 and the conductive agent 62 is spread on the bottom of the reactor 1 and compacted, and then the molten salt substance 7 is spread flatly on the mixture to form a structural feature of the lower reactant 6 and the upper molten salt substance 7.

In some embodiments of the present disclosure, by adding a conductive agent 62 doped between the powder particles of the metal oxide 61, the electrical conductivity of the reactant 6 can be elevated, which elevates the current conduction and the electrochemical reaction power, and improves the molten salt electro-reduction reaction effect without the use of coke, substantially reducing energy consumption and pollution of the environment.

In 402, the reactor is heated until the molten salt substance is melted and the electrical conductor is inserted within the molten salt substance. For example, the heating process may be induction heating, resistance wire heating, and fuel combustion heating.

In 403, the protective gas is continuously charged into the reactor through the gas charging and discharging mechanism while an exhaust gas is removed, and the power supply is switched on to perform the molten salt electro-reduction.

In some embodiments, argon gas in an argon gas tank is continuously charged into the reactor 1 through the filling tube 42, while the exhaust gas (e.g., air) is eliminated through the exhausting tube 43, and the exhaust gas is overflowing out of the molten salt substance 7 under buoyancy. The positive pole of the power supply 3 is electrically connected to the electrical conductor 2, and the negative pole of the power supply 3 is electrically connected to the base plate of the reactor 1, and the electro-reduction is carried out with a constant current or a constant voltage.

In 404, when the reaction in the barrel cavity is finished, the power supply is disconnected, the molten salt substance in an upper portion of the barrel cavity is poured out, and the retained substance in a lower portion is removed.

In 405, the metal is obtained by the retained substance.

In some embodiments, obtaining the metal via the retained substance may include: soaking the retained substance within ultrapure water a plurality of times to obtain the powdered metal. For example, after the solid retained substance in the lower portion of the reactor 1 is cooled, the retained substance obtained by electrically reducing molten salt is immersed within the ultrapure water to remove molten salt substance 7 remaining within the retained substance, the above process is repeated for 3-4 times, then the retained substance after removing the molten salt substance 7 is rinsed with anhydrous alcohol and then dried to obtain the powdered metal.

In some embodiments of the present disclosure, by adopting ultrapure water to soak the retained substance several times, and using anhydrous alcohol for rinsing and drying, the residual molten salt substance within the retained substance can be removed, thus contributing to enhancing the purity of the obtained powdered metal. At the same time, the ultrapure water and anhydrous alcohol are inexpensive and easy to obtain, which helps to reduce production costs.

In some embodiments, obtaining the metal by means of the retained substance of operation 405 may further include: heating the retained substance to obtain a liquid metal or a block metal after reaching a melting point of the metal. For example, the retained substance is heated by induction melting to volatilize and recover the molten salt substance 7 remaining within the retained substance, and the liquid or block metal is obtained after reaching the melting point of the metal.

In some embodiments of the present disclosure, heating the retained substance by induction melting helps to convert the powdered metal into liquid or lumpy metal, which can avoid safety issues caused by metal dust (e.g., powder explosions, etc.), and can help with operations such as preservation of the metal and subsequent processing.

Repeating the above operations 401-405, the metal oxide 61 is continuously reduced to metal, while the poured molten salt substance 7 may be repeatedly utilized, and the defects in a conventional process such as an ironmaking process that produces a large amount of slag may be avoided.

In some embodiments of the present disclosure, molten salt electro-reduction may be implemented by the method of metal preparation by electro-reduction of molten salt described in operations 401-405 has the advantage of having fewer process operations and a lower cost of metal preparation.

The device and method for metal preparation by electro-reduction of molten salt provided by some embodiments of the present disclosure are further described herein below in terms of the preparation of metal iron and the preparation of titanium aluminum alloys.

Exemplary, a process for preparing metallic iron through the molten salt electro-reduction includes following contents.

The corundum tube is inserted into the conductive crucible to obtain the reactor 1. A mixture of 20 g of Fe₃O₄ and 0.8 g of carbon powder mixture prepared as the reactant 6 is laid in the lower portion of the reactor 1 and compacted, then 160 g of a mixture of NaCl and NaF in a molar ratio of 1:1 prepared as the molten salt substance 7 is laid down above. The reactor 1 is placed into a heating furnace for heating, and after the temperature is raised to 800° C., the molten salt electro-reduction process is started. Protection is provided by continuously delivering argon into the heating furnace through the gas charging and discharging mechanism 4 to prevent oxidization of the metal at high temperature.

The connecting wires of power supply 3 (Goodwell PSM-3004) are connected to the cathode (the bottom of the reactor 1) and the anode (the graphite rod) of the device, respectively. The molten salt electro-reduction process is performed for 7.0 h at a current of 2.0 A, and all Fe₃O₄ is reduced to metallic iron.

The reaction in the barrel cavity of the reactor 1 is finished, the power supply 3 is disconnected, and the crucible is removed to pour out the molten salt substance 7 to be retained for recycling. The separation of the residual molten salt substance 7 from the metallic iron may be implemented in two ways.

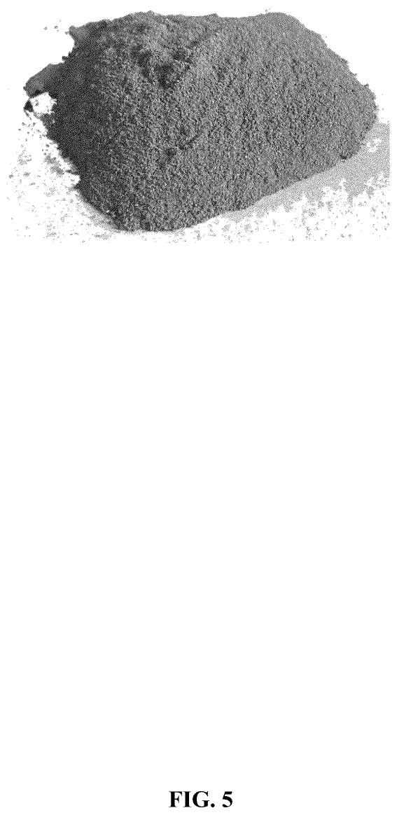

(1) A water washing process includes: after the crucible is cooled down, immersing and washing the retained substance inside the crucible in ultrapure water for 5-6 times to remove the residual molten salt substance 7, then rinsing the retained substance after removing the molten salt substance 7 2-3 times with anhydrous ethanol and drying to obtain a powdered pure metal as shown in FIG. 5.

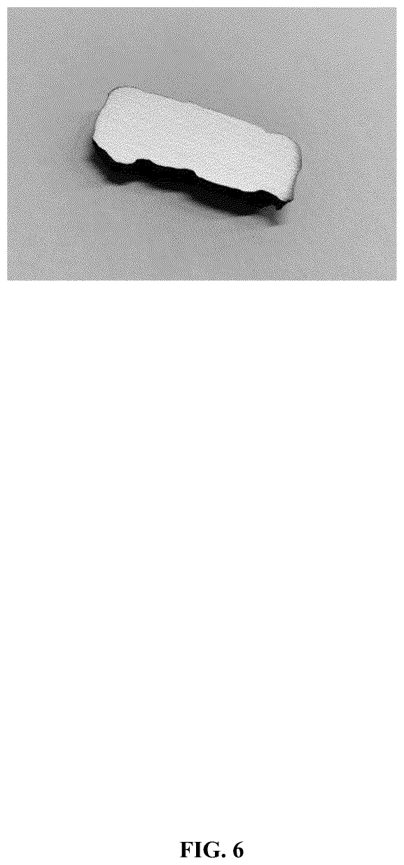

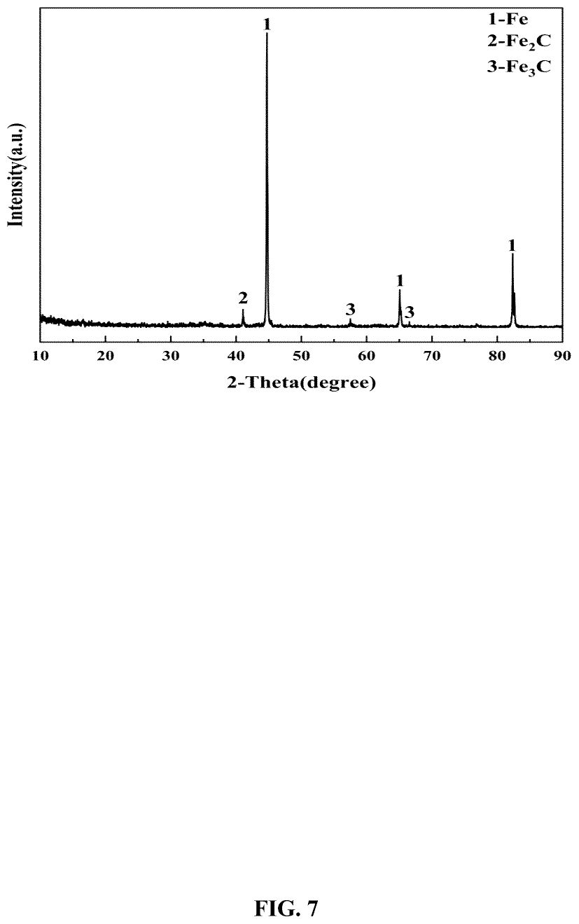

(2) A heating method includes: heating the retained substance after electro-reduction in a temperature range of 1000° C.-1200° C. in the induction furnace, so that the molten salt substance 7 is volatilized and recycled to obtain block metallic iron, as shown in FIG. 6. FIG. 6 is a photograph of an iron block obtained after the retained substance prepared in Example 1 of the present disclosure is heated by induction melting. The metal after the molten salt electro-reduction is subjected to XRD (X-Ray Diffraction) examination, and the results are shown in FIG. 7. The substance after electrically reduced by molten salt is pure iron metal except for a small amount of Fe and C compounds.

Exemplary, a process for preparing a titanium-aluminum alloy through the molten salt electro-reduction includes following contents.

The insulating sleeve is inserted in the graphite crucible to obtain the reactor 1, and the gap between the opening of the graphite crucible and the insulating sleeve is sealed with AB glue of a high temperature. A hole with a diameter of 1.5 mm and a depth of 0.5 mm is drilled at the upper end of the graphite crucible, and a polished wire with a length of 1.5 m is inserted into the hole and sealed with the AB glue of a high temperature, and then the reactor 1 is stood still for 12 h at room temperature. Afterwards, the wire is transferred to a tube furnace and is kept warm at 100° C. and 150° C. for two hours, then is cooled down to a room temperature and removed from the tube furnace.

The 20 g of TiO₂ is laid in the lower portion of the reactor 1 and compacted. The surface of 29.3 g of Al ingot is polished smooth and placed on the TiO₂ sample in the reactor 1. After that, the dried Na₃AlF₆ molten salt substance 7 is laid over the Al ingot. The reactor 1 is set in a heating furnace to be heated to a temperature of 1150° C., and argon is continuously delivered into the heating furnace to protect the metal from oxidation at a high temperature. The connecting wires of power supply 3 (Goodwell PSM-3004) are connected to the cathode (the bottom of the graphite crucible) and the anode (graphite rod) of the unit, respectively.

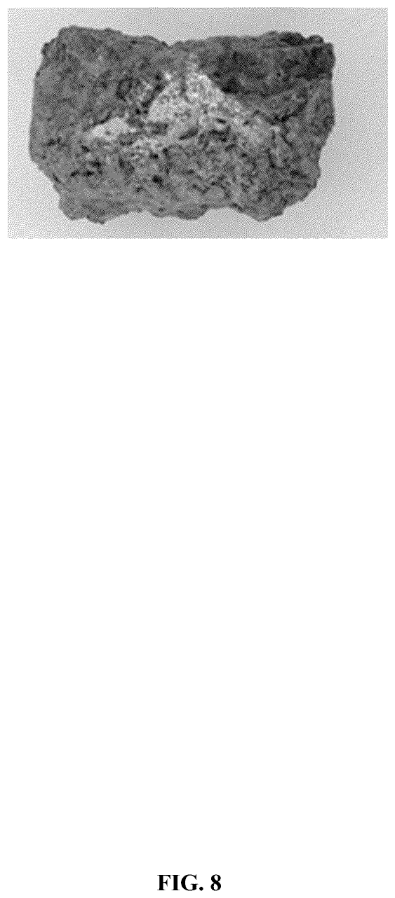

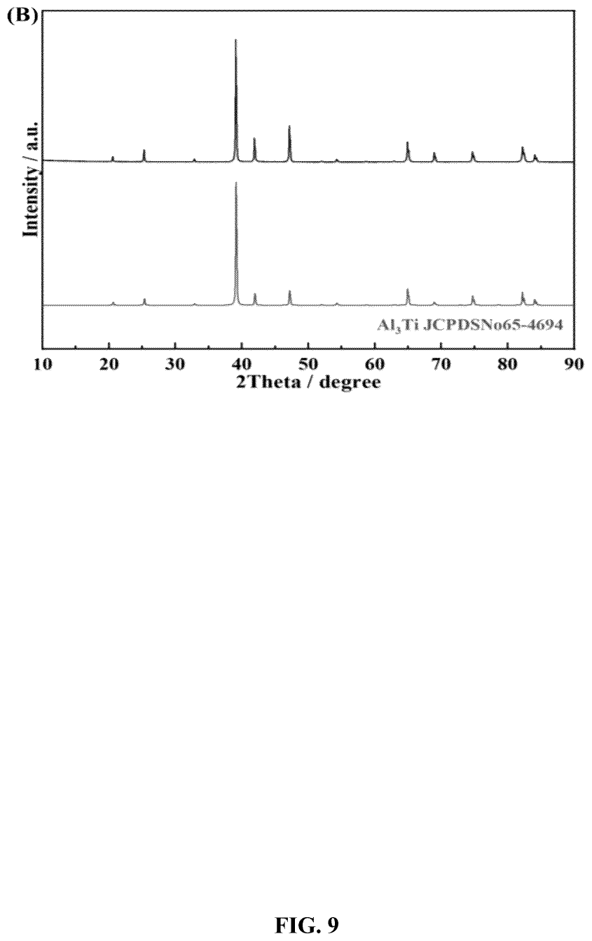

The electro-reduction process is carried out for 60 min at a voltage of 3.0 V, so that all of the TiO₂ is reduced to Al₃Ti. After the molten salt electro-reduction ends, the power supply 3 is disconnected, and the graphite crucible is removed to pour out the molten salt substance 7 to be retained for recycling. After the crucible is cooled, the retained substance in the crucible is soaked and cleaned with ultrapure water for 5-6 times to remove the residual molten salt substance 7, after which the product is put into 0.1 mol/L dilute hydrochloric acid for further decontamination, rinsed by anhydrous ethanol for 2-3 times, then the product is dried and sealed. The metal after the molten salt electro-reduction is gray as shown in FIG. 8, having a metallic luster after polishing, and the XRD results of the metal are as shown in FIG. 9, including that only the Al₃Ti phase exists without other impurities, and its diffraction peaks and standard card control do not deviate.

For example, the following is a cost analysis of the preparation of metal iron using the device and method for metal preparation by electro-reduction of molten salt provided in some embodiments of the present disclosure.

### 1. Major Costs

(1) Raw material cost: the raw materials are iron ore and biomass charcoal, the main component used in the laboratory stage is iron ore with Fe₃O₄; the added carbon source is biomass charcoal, and in the industry, it may be replaced by semi-coke which is less costly than metallurgical coke; and according to the data of the Steel Union, the market price of iron ore and the semi-coke is about 769 CNY/ton and 1616.67 CNY/ton, respectively.

### (2) Electricity Consumption Costs in Molten Salt Electro-Reduction Process

Taking constant current 2.0 A and electrolysis for 7 h as an example, the voltage profile of the molten salt electro-reduction process may be calculated to get the electricity consumption of about 28.1 W-h or 0.0281 kWh. According to the industrial electricity consumption of 0.5 CNY/kWh, the process consumes 0.01405 CNY.

### 2. Use of Raw Materials and Electricity Consumption in a Production of 1 Ton of Reduced Iron Powder

During the experiment, 10.04 g of iron is recovered by electrolyzing 20 g of Fe₃O₄ (iron powder ore) and 0.8 g of biomass charcoal (semi-coke) for 7 h at a constant current of 2.0 A. The process consumed 0.0281 kWh of electricity as calculated above (at 0.5 CNY/kWh, i.e., 0.01405 CNY). Then, when scaled up in equal proportions, it may be calculated that 2,800 kWh of electricity is needed to produce 1 ton of iron. According to the industrial electricity price of 0.5 CNY/degree, the cost of electricity to produce 1 ton of iron is about 1400 CNY.

### 3. Main Costs of Producing 1 Ton of Reduced Iron Powder

Producing 1 ton of iron requires 1.992 tons of iron powder ore, 0.07968 tons of semi-coke, and 2,800 kWh of electricity. Thus, it may be calculated that the cost of producing 1 ton of iron using this process is about 3060.65 CNY, which is significantly lower compared to the prior art.

It should be noted that the above descriptions are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A device for metal preparation by electro-reduction of molten salt, comprising a reactor, an electrical conductor, a power supply, a gas charging and discharging mechanism, and a closure mechanism; wherein
the reactor is a barrel body with a conductive base plate and an insulated peripheral wall and opens at one end, and a barrel cavity of the reactor is configured to lay down a reactant and a molten salt substance in sequence from bottom to top;
the electrical conductor is configured to be inserted into the molten salt substance after melting;
the reactor and the electrical conductor are disposed inside the closure mechanism, and the power supply is disposed outside the closure mechanism;
a positive pole of the power supply is electrically connected to the electrical conductor, and a negative pole of the power supply is electrically connected to the conductive base plate; and
the gas charging and discharging mechanism is configured to continuously charge a protective gas into the reactor while removing an exhaust gas.

2. The device according to claim 1, wherein the reactor includes the conductive base plate and a first insulating cylinder, the first insulating cylinder being disposed on the conductive base plate.

3. The device according to claim 2, wherein an outer diameter of the conductive base plate is not smaller than an outer diameter of the first insulating cylinder.

4. The device according to claim 1, wherein the reactor includes a conductive barrel and a second insulating cylinder; and
the second insulating cylinder is inserted into the conductive barrel, and a bottom surface of the second insulating cylinder against an inner bottom surface of the conductive barrel.

5. The device according to claim 1, further comprising a first conductive rod; wherein
one end of the first conductive rod is electrically connected to the electrical conductor, and the other end is electrically connected to the positive pole of the power supply and penetrates the closure mechanism.

6. A method for metal preparation by electro-reduction of molten salt implemented by a device for metal preparation by electro-reduction of molten salt, wherein the device includes a reactor, an electrical conductor, a power supply, a gas charging and discharging mechanism and a closure mechanism; the reactor is a barrel body with a conductive base plate and an insulated peripheral wall and opens at one end, a barrel cavity of the reactor is configured to lay down a reactant and a molten salt substance in sequence from bottom to top; the electrical conductor is configured to be inserted into the molten salt substance after melting; the reactor and the electrical conductor are disposed inside the closure mechanism, and the power supply is disposed outside the closure mechanism; a positive pole of the power supply is electrically connected to the electrical conductor, and a negative pole of the power supply is electrically connected to the conductive base plate; the gas charging and discharging mechanism is configured to continuously charge a protective gas into the reactor while removing an exhaust gas; and
the method includes:
laying the reactant and the molten salt substance in sequence from bottom to top in the barrel cavity of the reactor;
heating the reactor until the molten salt substance melt and then inserting the electrical conductor into the molten salt substance;
continuously charging the protective gas into the reactor through the gas charging and discharging mechanism while removing the exhaust gas, and switching on the power supply to perform a molten salt electro-reduction reaction;
when the molten salt electro-reduction reaction in the barrel cavity is finished, disconnecting the power supply, pouring out the molten salt substance in an upper portion of the barrel cavity, and removing a retained substance in a lower portion of the barrel cavity; and
obtaining a metal by the retained substance.

7. The method according to claim 6, wherein the obtaining a metal by the retained substance includes:
soaking the retained substance in ultrapure water a plurality of times to obtain a powdered metal.

8. The method according to claim 6, wherein the obtaining a metal by the retained substance includes:
obtaining a liquid metal or a block metal by heating the retained substance to reach a melting point of the metal.

9. The method according to claim 6, wherein the molten salt substance is one or more of chloride or fluoride.

10. The method according to claim 6, wherein the reactant includes a metal oxide and a conductive agent.
